(19) United States
(12) Patent Application Publication
(10) Pub. No.: US 2006/0036345 A1
(43) Pub. Date: Feb. 16, 2006

(54) Systems and method for lights-out manufacturing

(76) Inventors: An Cao, Arlington, MA (US); Wai T. Chan, Newburyport, MA (US); Jill P. Card, West Newbury, MA (US)

Correspondence Address: GOODWIN PROCTER LLP;PATENT ADMINISTRATOR, EXCHANGE PLACE, BOSTON, MA, 02109-2881, US

(21) Appl. No.: 11/199,815

(22) Filed: Aug. 9, 2005

Related U.S. Application Data
(60) Provisional application No. 60/600,017, filed on Aug. 9, 2004.

(51) Int. Cl. G06F 19/00

(52) U.S. Cl. 700/108; 702/182

(57) ABSTRACT

Complex process control and maintenance are performed utilizing a nonlinear regression analysis to determine optimal tool-specific adjustments based on operational metrics, process adjustments and maintenance activities.

### CROSS REFERENCE TO RELATED APPLICATIONS

The present application claims the benefit of and priority to U.S. provisional application Ser. No. 60/600,017, filed Aug. 9, 2004, the entire disclosure of which is herein incorporated by reference.

### FIELD OF THE INVENTION

The invention relates generally to the field of manufacturing and process control and, in particular, to using an automated controller to operate a manufacturing environment that is not dependent on humans to make process-control decisions.

### BACKGROUND

Process prediction and control is crucial to optimizing the outcome of complex multi-step production processes. For example, the production process for integrated circuits comprises hundreds of process steps (i.e., sub-processes). Each process step, in turn, may have several controllable parameters, or inputs, that affect the outcome of the process step, subsequent process steps, and/or the process as a whole. In addition, the impact of the controllable parameters and maintenance actions on the process outcome may vary from process run to process run, day to day, or hour to hour. The typical integrated circuit fabrication process thus has a thousand or more controllable inputs, any number of which may be cross-correlated and have a time-varying, nonlinear relationship with the process outcome. As a result, process prediction and control is crucial to optimizing process parameters and to obtaining, or maintaining, acceptable outcomes and improving product quality, increasing throughput, and reducing costs.

However, intra- and inter-process dependencies, multiple product lines, ever-changing operating environments, and the variability of process inputs often makes it difficult to attain these goals. Inevitably, human interaction is required to identify defects, alter processing steps, and adjust processing parameters to meet the desired output metrics. These can be costly and time-consuming, are prone to mistakes, and can be inconsistent among different individuals and over time. In some instances, the use of process monitoring and control systems can automate certain aspects of process control. However, the inherent inflexibility of automated, rule-driven control systems restricts their ability to cope with changing situations and to make the downstream adjustments necessary to meet the desired processing targets for complex manufacturing processes.

Semiconductor manufacturing is one such process, in part due to the multi-step nature of the process, the dependencies among the steps, and the complex technologies required for manufacturing semiconductor wafers, such as the challenge of applying multiple additive layers of silicon onto the wafers. Furthermore, because the failure of any individual semiconductor wafer element can cause the entire wafer to be scrapped, the tolerance for defects is extremely low.

The human element also increases the difficulty of semiconductor manufacturing. Whenever humans manually perform any action such as repairing equipment, diagnosing equipment failure, or determining the correct targets for processing equipment at either an individual process point or for a set of sequential process steps, mistakes can be introduced. Even process-control engineers whose principal task is monitoring and correcting control algorithms for production efficiency can make mistakes that can cause scrap and loss. Eliminating the need for human intervention and automating production helps improve the semiconductor manufacturing process, but the automation should be adaptive, generic, and totally synergistic in its design to handle the ever-changing environments and still achieve high productivity and quality of product.

### SUMMARY OF THE INVENTION

One goal of complex production enterprises, such as the semiconductor fabrication industry, is to be able to implement a totally robotic process using automated control algorithms that maintains optimal throughput and yield in the face of continuously changing conditions. Such an operating environment is often referred to as a “lights-out” fab.

In accordance with the present invention, a set of software components operates independently but synergistically in an automated, cascade fashion and adapts to changing processing parameters in order to produce optimal final results, while acknowledging ever-changing conditions and products mixes over time. As a result, the process can operate without (or with minimal) human intervention.

In one aspect, the invention provides a system for controlling a process that comprises multiple sub-processes, each having associated operational metrics. The system includes sensors that obtain operational metrics from a plurality of tools that are performing the sub-process operations, a yield controller that predicts the output performance of the process based on the metrics, and an optimizer that determines, based on the predicted output performance, one or more actions (e.g., part replacements, recipe adjustments and/or recommending maintenance actions that are performed on the tools) to be taken affecting the sub-processes, thereby maximizing process performance.

In some embodiments, the system also includes a plurality of tool controllers, each associated with one or more of the tools, for implementing the actions determined by the optimizer. The system may also include a data storage module for storing target process metrics, corrective action costs, maintenance actions, process state information, and/or possible corrective actions. In some embodiments, the yield controller can include a high-level controller for determining relationships between the operational metrics and the output performance of the process, as well as a low-level controller for determining the relationships between the output performance and the actions that affect the sub-processes. The relationships may be modeled using, for example, a non-linear regression model, which in some instances may include a neural network.

In another aspect, the invention comprises an article of manufacture having a computer-readable medium with the computer-readable instructions embodied thereon for performing the methods described in the preceding paragraphs. In particular, the functionality of a method of the present invention may be embedded on a computer-readable medium, such as, but not limited to, a floppy disk, a hard disk, an optical disk, a magnetic tape, a PROM, an EPROM, CD-ROM, or DVD-ROM. The functionality of the method may be embedded on the computer-readable medium in any number of computer-readable instructions, or languages such as, for example, FORTRAN, PASCAL, C, C++, Tcl, BASIC and assembly language. Further, the computer-readable instructions can, for example, be written in a script, macro, or functionally embedded in commercially available software (such as, e.g., EXCEL or VISUAL BASIC).

In another aspect, the invention provides a method for controlling a complex process, where the process includes multiple sub-processes. The method includes obtaining operational metrics from tools performing the sub-processes and, based on the operational metrics, predicting the outcome of the process. The method also includes determining actions (e.g., part replacements, recipe adjustments and/or recommending maintenance actions that are performed on the tools) to be taken that affect the sub-processes based on the predicted output performance, thereby maximizing the performance of the process.

In some embodiments, the method also includes implementing the actions on the tools that perform the sub-processes. Predicting the operational outcome and determining actions to be taken can be based on determined relationships between the operational metrics and the outcome of the process, as well as the outcome of the process and the actions affecting the sub-processes. The relationships can be in the form of a nonlinear regression model such as, for example, a neural network. The actions to be taken can also, in some cases, be based in part on target process metrics, corrective action costs, maintenance actions, process state information, and/or possible corrective actions.

The foregoing and other objects, aspects, features, and advantages of the invention will become more apparent from the following description and from the claims.

### BRIEF DESCRIPTION OF THE DRAWINGS

A fuller understanding of the advantages, nature and objects of the invention may be had by reference to the following illustrative description, when taken in conjunction with the accompanying drawings. The drawings are not necessarily drawn to scale, and like reference numerals refer to the same items throughout the different views.

FIG. 1 schematically illustrates a process in which the prediction and optimization processes in which various embodiments of the invention may operate.

FIG. 2 is a flow diagram illustrating the prediction and optimization of a process according to one embodiment of the present invention.

FIGS. 3A and 3B are flow diagrams further illustrating the prediction and optimization of a process according to various embodiments of the present invention.

FIG. 4 is a flow diagram further illustrating the prediction and optimization of a process according to one embodiment of the present invention.

FIG. 5 is a schematic diagram of one embodiment of a system adapted to practice the methods of the present invention.

FIG. 6 is a schematic illustration of an illustrative structure produced by a metalization process in which the methods and systems of the present invention operate.

FIG. 7 is a schematic illustration of four sequential processing steps associated with manufacturing a metal layer and non-linear regression model training according to various embodiments of the present invention.

FIG. 8 is a schematic illustration of four sequential processing steps associated with manufacturing a metal layer and a schematic illustration of process prediction and optimization according to various embodiments of the present invention.

FIG. 9 illustrates an approach to mapping between sub-process metrics and sub-process operational variables according to various embodiments of the present invention.

FIG. 10 is a schematic illustration of a hierarchical series of sub-process and process models and process prediction according to various embodiments of the present invention.

FIG. 11 is a schematic illustration of a hierarchical series of sub-process and process models and process optimization according to various embodiments of the present invention.

### DETAILED DESCRIPTION

The invention provides a method and system for optimizing process parameters using observed and predicted process metrics and operational variables. As used herein, the term “metric” refers to any parameter used to measure the outcome or quality of a process or sub-process (e.g., the yield, a quantitative indication of output quality, etc.) and may include parameters determined both in situ during the running of a sub-process or process, and ex situ, at the end of a sub-process or process, as described above. The present discussion will focus on wafer production, but it should be understood that the invention is applicable to any complex process, with references to wafers being for purposes of explanation only.

As used herein, the term “operational variables” includes process controls that can be manipulated to vary the process procedure, such as set point adjustments (referred to herein as “manipulated variables”), variables that indicate the wear, repair, or replacement status of a process component(s) (referred to herein as “replacement variables”), and variables that indicate the calibration status of the process controls (referred to herein as “calibration variables”). As used herein, the term “maintenance variables” is used to refer collectively to both replacement variables and calibration variables. Furthermore, it should be understood that acceptable values of process operational variables include, but are not limited to, continuous values, discrete values and binary values.

The operational variable and metric values may be measured values, normalized values, and/or statistical data derived from measured or calculated values (such as a standard deviation of the value over a period of time). For example, a value may be derived from a time segment of past information or a sliding window of state information regarding the process variable or metric. A variable is considered an input if its value can be adjusted independently from other variables. A variable is considered an output if its value is affected by other input variables.

For example, where the process comprises plasma etching of silicon wafers, manipulated variables (“MV”) may include, e.g., the radio frequency (RF) power and process gas flow of one or more plasma reactors. Replacement variables (“RV”) may include, e.g., the time since last plasma reactor electrode replacement and/or a binary variable that indicates the need to replace/not replace the electrodes. Calibration variables (“CalV”) may include, e.g., time since last machine calibration and/or the need for calibration.

As an example, the initial fabrication process of a 300-mm semiconductor wafer structure requires in excess of 450 sequential steps. The wafer can involve a number of full metal lines, usually ranging from four to six, with the end of a line being the culmination of a series of circuits of various electronic materials that are tested for both performance and yield. Each metal line is cumulative of the lines laid down before. As an illustration, a first metal testing for performance and yield is performed after approximately 100 steps; a second metal testing is performed after an additional 150 process steps, and so on. The second metal testing will be affected by the adequacy of the build and test programs performed on the first metal line, the first and second will affect the third, etc.

In addition to the 450-step front-end build-up processing of the wafer, other complexities make semiconductor manufacturing difficult. Any piece of processing equipment may process hundreds of different products, each product may require a change in the “recipe” of process settings used to process the product, and different wafers often require different circuit designs. These factors can lead to different behaviors both of the end chip and the equipment and materials being used to manufacture the wafer, resulting in an almost constant change in the thousands of elements used to process the wafers. One example is the use of different gas and valves from different supply vendors, each having different performance and reliability specifications and capabilities. In short, the processes can change constantly, and the equipment is highly sensitive and requires constant monitoring and maintenance. However, the importance of maintaining critical throughput schedules and avoiding unscheduled equipment down time remains a high priority.

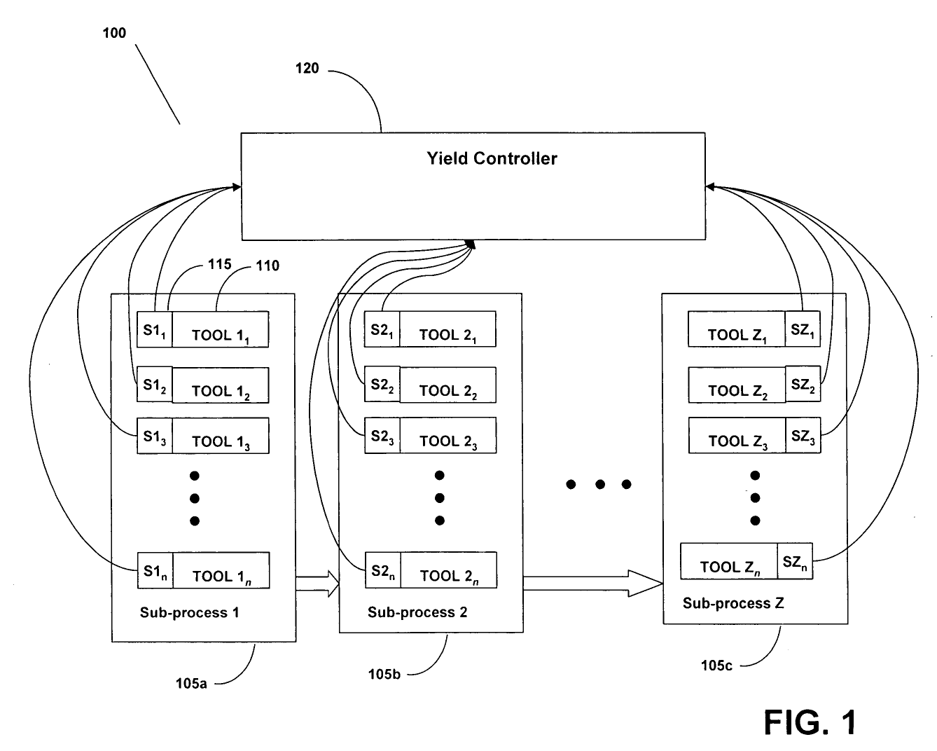

Referring to FIG. 1, an exemplary complex process includes a set of sub-processes 105a, 105b, and 105c (generally, 105), which constitute steps within the overall process. Although only three sub-processes are indicated for illustrative purposes, it should be understood that, as described above, the process may include hundreds or even thousands of sub-processes. Each sub-process may be performed by one or more tools 110, some or all of which are monitored by corresponding sensors 115. The sensors 115 monitor various operational aspects of the tools, such as temperature and gas flow pressure, as well as various sub-process metrics. For sensors that are highly complex in nature (e.g., optical emission spectrometers), the amount of data recorded per wafer can be as high as hundreds of thousands of data points. Thus, in some cases an initial extraction and compression of data must occur in order to make the metrology information useful for target mapping and sensitivity evaluation. The sensors 115 perform the data compression and information extraction prior to the data being used as a metrology source. Subsequently, a yield controller returns the abstract high-order dimensional specification target and sensitivity on yield information. Effectively, the yield controller returns the N-dimensional metrology target to hit and the impact of the N-dimensional deviation from that target on yield for each complex sensor. A more detailed example of the wafer fabrication process, including examples of the operational variables and sub-process metrics, is provided below. It should be understood, however, that focus on semiconductor fabrication is for illustrative purposes only; the present invention may be usefully applied to any complex production, fabrication, chemical or other process.

The goals of controlling such a process can be expressed as follows: (i) adhere to precision output target specifications from every process step; (ii) assure that each piece of equipment can produce output products that meet the target specifications; (iii) maximize equipment availability for throughput scheduling; and (iv) adhere to the correct targets for each product recipe. For example, even if all 450 individual sub-processes are meeting their individual targets, optimal targets should also consider the final metal yields and overall system performance targets across all of the sub-processes. Likewise, wafer-to-wafer metrics describing the results of the processing steps are constantly monitored to ensure that no production of unacceptable wafers goes unnoticed for more than a few seconds. Unnoticed mistakes, even those only lasting a few seconds, can cause hundreds or even thousands of wafers to be incorrectly processed and therefore scrapped.

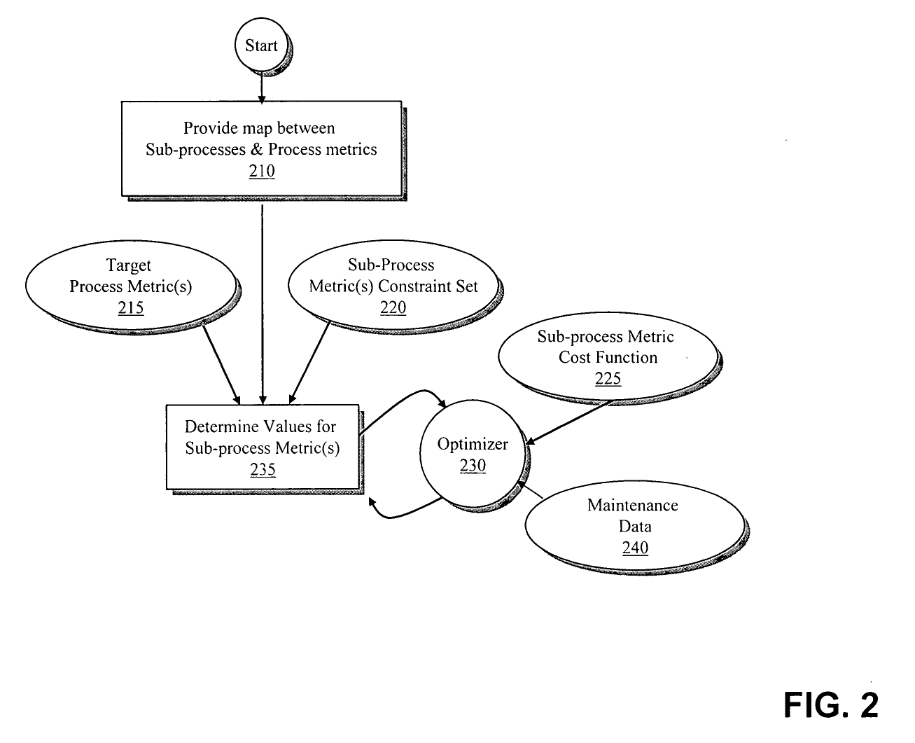

FIG. 2 illustrates one embodiment of a method of process optimization whereby relationships between the process metrics that describe the efficiency and/or quality of the process and the various sub-process metrics are determined in accordance with the present invention. The method begins by providing a map (step 210) between the metrics of the process 100 and the metrics of two or more sub-processes 110 that define the process, one or more target process metrics 215, an acceptable range 220 of values for the sub-process metrics that serve as metric constraints, and a cost function 225 describing the costs associated with deviations in the sub-process metrics. Preferably, the map is realized in the form of a nonlinear regression model trained in the relationship between the process metrics and sub-process metrics such that the model can predict one or more process metric values from one or more sub-process metric values. Using the map, process targets 215, cost function 225, and constraints 225, an optimizer 230 builds an optimization model that determines values for the sub-process metrics 235 that are within the constraint set, and that produce process metric(s) that are as close as possible to the target process metric(s) while minimizing the overall costs. These become the target sub-process metrics for each sub-process 105. In some embodiments, maintenance data 240 relating to one or more tools that perform the sub-processes is included as inputs into the optimization process. Maintenance data may include, by way of non-limiting examples, maintenance history, maintenance costs, and maintenance schedules.

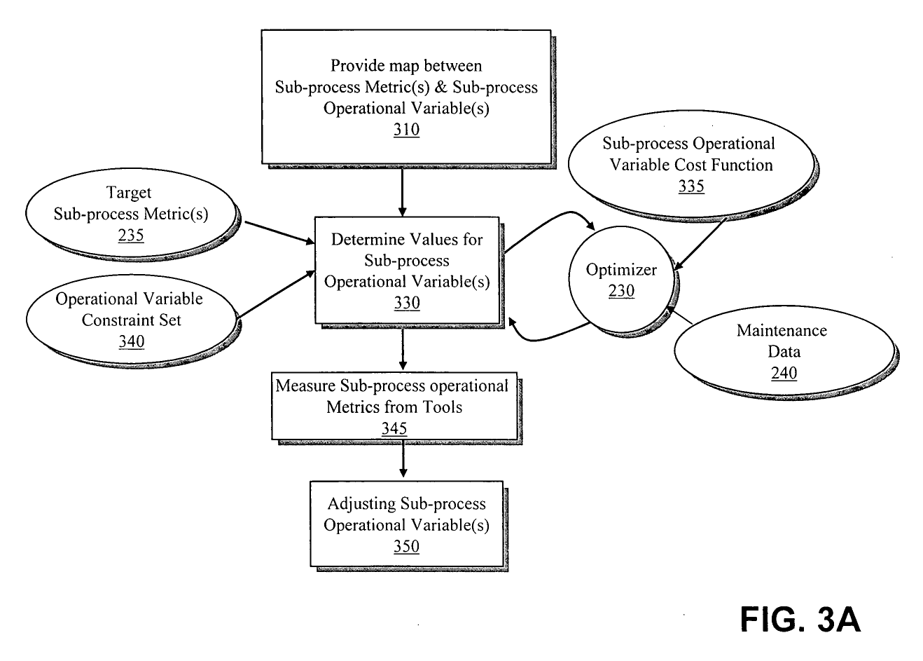

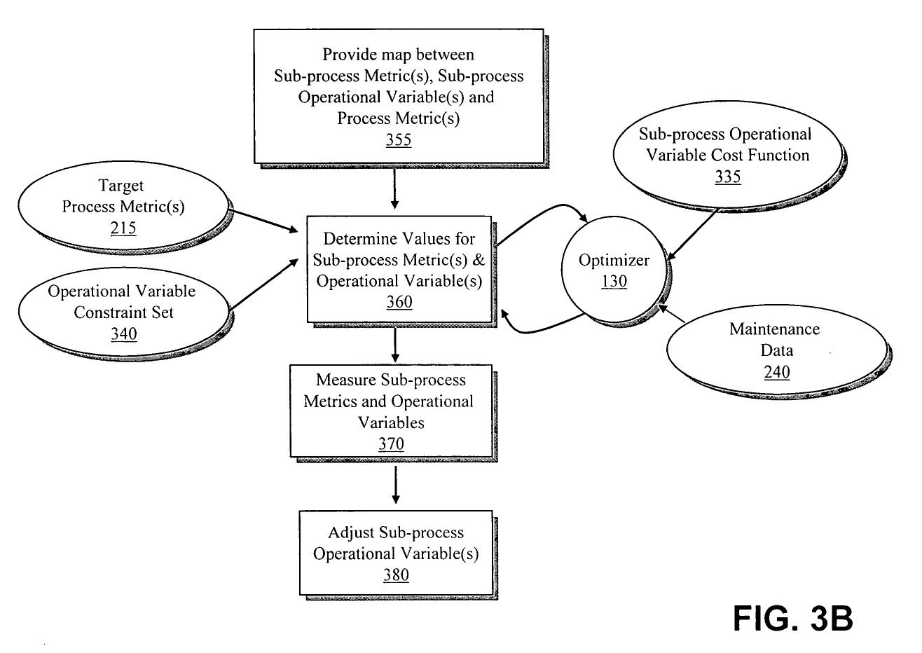

Referring to FIG. 3A, the invention further provides a map (step 310) between one or more sub-process metrics and one or more operational variables of the associated sub-processes, which, in some embodiments, may be extracted from one or more tools performing the sub-processes. (The operational variables may be) adjusted as necessary to maintain optimal process performance. Similar to the map between the process metrics and the sub-process metrics, the map between one or more sub-process metrics and one or more sub-process operational variables is preferably derived using a nonlinear regression model trained in the relationship between the sub-process metrics and sub-process operational variables such that the nonlinear regression model can predict one or more target sub-process operational variable values (step 330) for one or more operational variable values that describe the operations of the various tools performing the sub-processes. The optimizer 130 (which, in some cases may be the same optimizer described above, or in other cases a different optimizer using similar techniques) uses the sub-process metric and operational variable map, an operational variable cost function 335, the target sub-process metrics 235, and an operational variable constraint set 340 to determine the target sub-process operational variable values. The sensors 115 may, in some instances, measure and supply ongoing operational metrics (step 345), which may then be compared to the target values generated in step 330, and proper adjustments determined (step 350). As described above with respect to the sub-process metrics, maintenance data 240 relating to one or more tools that perform the sub-processes may also be included as inputs into the optimization process.

Parameters may be optimized from two different levels of a process (e.g., sub-process metrics and sub-process operational variables) against a parameter of a higher level (e.g., process metrics). Referring to FIG. 3B, in one embodiment, the method provides a map (step 355) between one or more metrics and operational variables of a sub-process and one or more process metrics. Preferably, the map is realized as a nonlinear regression model trained in the relationship between the sub-process metrics and sub-process operational variables and the process metrics such that the nonlinear regression model can predict one or more process metric values from one or more sub-process metric and sub-process operational variable values.

The sub-process metric, the operational-variable and process-metric map generated in step 355, an optimizer 130 having one or more optimization models, and the operational-variable cost function 335 are then used to determine target values for the sub-process metrics and target values for the sub-process operational variables 360 that (i) are within a sub-process metric and sub-process operational variable constraint set 340, (ii) produce at the lowest cost the process metric, and (iii) are as close as possible to the target process metric values 215. Again, maintenance data 240 may also be included as inputs to the optimization model.

In addition, in various embodiments, the optimization method may further comprise measuring one or more sub-process metrics, one or more sub-process operational variables, or both (step 370), and adjusting one or more of the sub-process operational variables substantially to its associated target value (step 380).

The relationships determined using the methods described above can be further extended down to the tool level to encompass the entire fabrication process across all product lines, production routes and tools, thus facilitating a completely automated “lights-out” fabrication process.

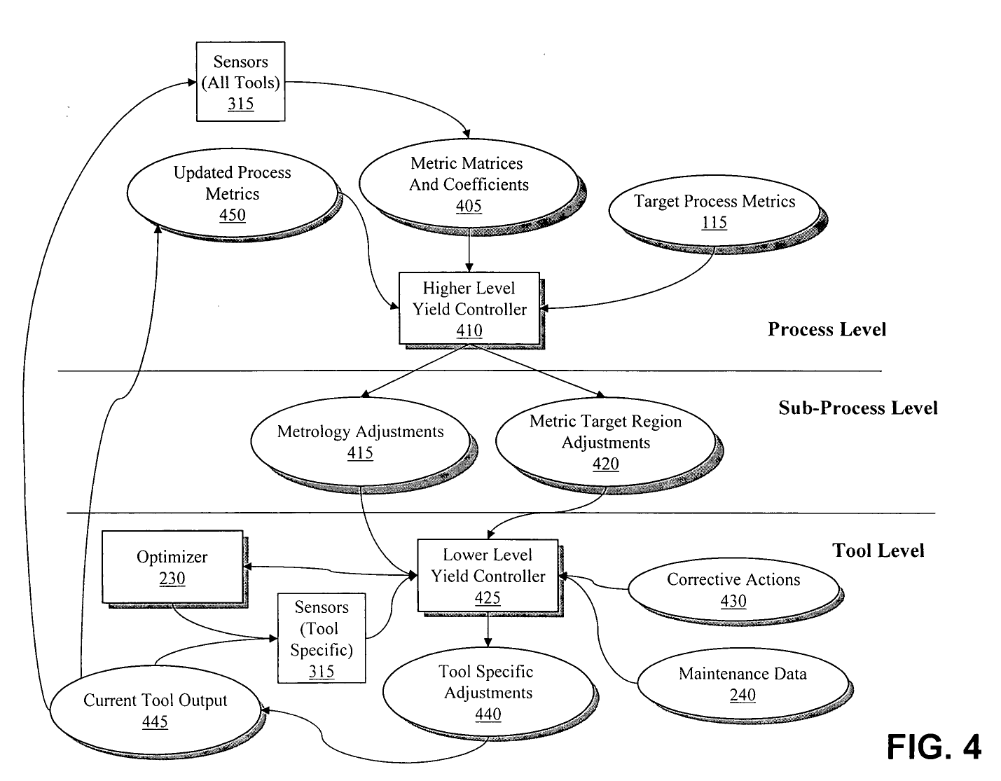

As described above and with reference to FIG. 4, a series of sensors 115 monitor the metrology results from individual tools 110 performing the various process and sub-process steps 105. The target values may be measured for every wafer, every n^{th} wafer, in real-time during processing of each wafer, or sampled for a particular lot size (e.g., 25 wafers). The metrics can be measured in-situ (within the processing equipment), in-line (measured between steps within the processing equipment), or ex-situ (after the processing of a given step, and in some cases using a different piece of equipment). In some embodiments where it may not be feasible to consistently meet a specific target metric, metrology also can include determining if the observed metrics are within a specification target range. The metrology results represent data across all recipes being processed by a piece of equipment and across any similar pieces of processing equipment found within a process “bay.” The results are extracted from the tools 110 by the sensors 115, which may, in some cases, be co-located with the tools 110, or in other cases may be connected to the tools 110 via a wired and/or wireless network. The sensors 115 compress the data into various low-dimension sensor-metric matrices based on the various product lines that flow through the tools at different process steps, and provide the metric matrices and extraction coefficients 405 to the high-level yield controller 410.

The high-level yield controller 410 then uses the metric matrices and extraction coefficients 405 and target process metrics 215 as input into a prediction model to predict the final end-of-line performance and the associated yield results at the process level. Based on these results, necessary adjustments to the overall process metrology 415, process targets 420, and/or product mix can also be determined. Once the model simulating yield and performance is built, the high-level yield controller 410, implementing the model, feeds the optimal process and sub-process targets, target operational variable values, and the risks of missing the targets for each sequential process step to local lower-level controllers 425 located throughout the processing sequence. In cases where multiple recipes are being used, optimal targets are included for each recipe relative to a final yield for each tool, and tool-specific adjustments 440 can be determined that maximize process performance given the process and sub-process target values and tool-specific data. In some embodiments, maintenance data 240 and possible corrective actions 430 (along with their associated risks and costs) are considered by the lower-level controller as well.

The feedback is preferably adaptive over time and can be reset as needed for all of the processing steps based on updated metrology results obtained from the sensors 115. The high-level yield controller 410 takes the targets to be hit at each individual sub-process equipment point in a given sequence of processing steps and may utilize techniques of artificial intelligence (e.g., neural networks) and adaptive algorithms to evaluate whether the sequence can meet the determined metrology targets. The goal of the system is to minimize the deviations from the targets for every wafer, and understand the sensitivity of adherence to the targets on overall process yield.

In instances where the current tool outputs 445 of one or more sub-processes are not meeting their targets as set by the high-level yield controller 410, the optimizer 230 calculates and sends new targets to the low-level tool controllers 425 at the subsequent sub-process steps. The new targets are based on real-time process metrics and the overall process yield goals, and represent the adjusted process targets that must be met in order to maximize the overall process yield given the additional constraint(s) of having missed targets at previous process steps. This ensures that the best possible yield and performance outcome will be achieved as the material proceeds down the manufacturing steps to final test.

Once the optimizer 230 establishes the new targets for any given process to hit for a given lot of product at a given tool, all of the metrology sensor targets and deviation sensitivities (and consequently specification limits) are updated (step 450) for that product at that process step for that recipe. Therefore, all sensors 315 that exist across all pieces of equipment now have established targets and known influence upon overall process yield for different recipes based on the current operating conditions. Because there can be hundreds of sensors measuring the tools in the fabrication process, and because the data produced by many of these sensors is not well understood and difficult to incorporate into process-control management, the sensor data represents a very large source of previously unused information.

As the optimizer continually returns the new optimal output targets and process sensitivity information to the local tool controllers at the individual process points to maximize yield, the sensors continue to measure the quality aspects relating to the yield, and the local controllers proceed to implement product-specific recipe changes and recommended equipment maintenance actions identified by the optimizer that will help the system achieve the new targets. The number of tool-specific targets may be numerous—in some cases as many as there are sensors measuring different aspects of local process quality. The combination of these elements—the yield controller, the sensors, the optimizer, and the local controllers—can operate automatically and adaptively, thus removing (or reducing) the need for human intervention in the adjustment of recipes, targets, and the identification of needed maintenance actions. The operations are generally performed on a wafer-to-wafer basis, and adapt to all processing changes occurring within the process in real time.

The prediction model is therefore useful and accurate in its representation of what happens to the process yield from any given process point and the impact of events at each step on the end-of-line yield. The integration of all three components is a significant step toward “lights out” manufacturing that does not rely on, and is not hindered by, human decisions during the production process.

In the various embodiments described above, the map between the process metrics and sub-process metrics, the map between the sub-process metrics and operational variables, and the map among the process metrics, sub-process metrics and the operational variables may be provided, for example, through the training of a nonlinear regression model against measured sub-process, process, and operational variable metrics. As an example, the sub-process metrics from each of the sub-processes serve as the input to a nonlinear regression model, such as a neural network. The output of the nonlinear regression model is the process metric(s). The nonlinear regression model is preferably trained by comparing a calculated process metric(s), based on measured sub-process metrics for an actual process run, with the actual process metric(s) as measured for the actual process run. The difference between calculated (i.e., predicted) and measured process metric(s), or the error, is used to compute the corrections to the adjustable parameters in the regression model. If the regression model is a neural network, these adjustable parameters are the connection weights between the layers of the neurons in the network.

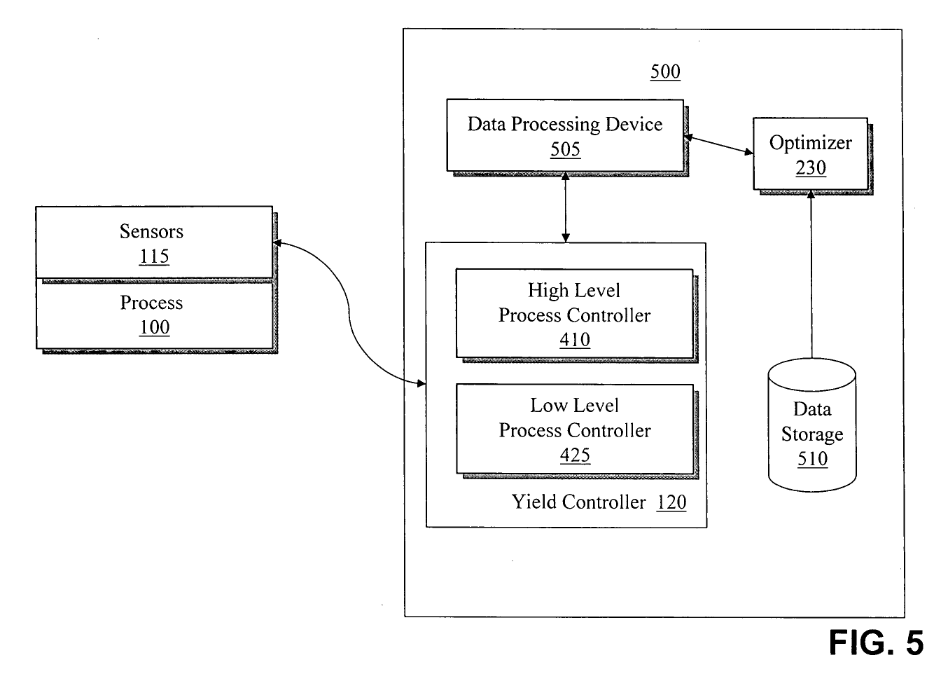

A representative system implementing the techniques set forth above is shown in FIG. 5. The system 500 comprises one or more data sensors 115 in electronic communication with a data-processing device 505 and yield controller 510. The sensors 115 may comprise any device capable of receiving information on variables, parameters, or process metrics of the process 100 or sub-processes 105 from the tools 110 performing the sub-processes or measuring the output of the process 100. For example, the sensor 115 may comprise an RF power monitor for a sub-process tool 110. The data processing device 505 may comprise an analog and/or digital circuit adapted to implement the functionality of one or more of the methods of the present invention using at least in part information provided by the sensors 115. The information may be used, for example, to directly measure one or more metrics, operational variables, or both, associated with a process or sub-process. The information may also be used directly to train a non-linear regression model, implemented using data processing device 505 in a conventional manner, in the relationship between one or more sub-process and process metrics, and sub-process metrics and sub-process operational variables (e.g., by using process parameter information as values for variables in an input vector and metrics as values for variables in a target output vector). Alternatively or in addition, the information may be used to construct training data set for later use. In addition, in one embodiment, the systems of the present invention are adapted to conduct continual, “on-the-fly” training of the non-linear regression model.

The system further comprises a yield controller 510 in electronic communication with the data-processing device 505. The yield controller may be any device capable of adjusting one or more process, sub-process, or tool operational variables in response to a control signal from the data-processing device 505. The yield controller 510 may comprise mechanical and/or electromechanical mechanisms to change the operational variables. As described above, the yield controller 510 may include a high-level controller for determining process-level adjustments, and a low-level controller that utilize tool-specific data and process level adjustments from the high-level controller to implement tool-specific adjustments that are consistent with the overall process parameters.

In some embodiments, the data processing device 505 may implement the functionality of the methods of the present invention as software on a general purpose computer. In addition, such a program may set aside portions of a computer's random access memory to provide control logic that affects one or more of the measuring of metrics, the measuring of operational variables, the provision of target metric values, the provision of constraint sets, the prediction of metrics, the determination of metrics, the implementation of an optimizer, determination of operational variables, and detecting deviations of or in a metric. In such an embodiment, the program may be written in any one of a number of high-level languages, such as FORTRAN, PASCAL, C, C++, C#, java, LISP, PERL, Tcl, or BASIC. Further, the program can be written in a script, macro, or functionality embedded in commercially available software, such as EXCEL or VISUAL BASIC. Additionally, the software could be implemented in an assembly language directed to a microprocessor resident on a computer. For example, the software can be implemented in Intel 80x86 assembly language if it is configured to run on an IBM PC or PC clone. The software may be embedded on an article of manufacture including, but not limited to, “computer-readable program means” such as a floppy disk, a hard disk, an optical disk, a magnetic tape, a PROM, an EPROM, or CD-ROM.

In another aspect, the present invention provides an article of manufacture where the functionality of a method of the present invention is embedded on a computer-readable medium, such as, but not limited to, a floppy disk, a hard disk, an optical disk, a magnetic tape, a PROM, an EPROM, CD-ROM, or DVD-ROM. The functionality of the method may be embedded on the computer-readable medium in any number of computer-readable instructions, or languages such as, for example, FORTRAN, PASCAL, C, C++, C#, java, LISP, PERL, Tcl, BASIC and assembly language. Further, the computer-readable instructions can, for example, be written in a script, macro, or functionally embedded in commercially available software (such as, e.g., EXCEL or VISUAL BASIC).

Exemplary Nonlinear Mapping Model

In various embodiments of the present invention, the map between sub-process metrics and sub-process operational variables can be provided, for example, by determining the map through the training of a nonlinear regression model against measured sub-process metrics and sub-process operational variables. The sub-process operational variables from the sub-processes serves as the input to a nonlinear regression model, such as a neural network. The output of the nonlinear regression model is the sub-process metric(s). The nonlinear regression model is preferably trained by comparing a calculated sub-process metric(s), based on measured sub-process operational variables for an actual sub-process run, with the actual sub-process metric(s) as measured for the actual sub-process run. The difference between the calculated and measured sub-process metric(s), or the error, is used to compute the corrections to the adjustable parameters in the regression model. If the regression model is a neural network, these adjustable parameters are the connection weights between the layers of the neurons in the network.

In various embodiments, a nonlinear regression model for use in the present invention comprises a neural network. Specifically, in one version, the neural network model and training is as follows. The output of the neural network, r, is given by

$${r}_{k} = {\sum }_{j} [ {W}_{jk} \cdot tanh ( {\sum }_{i} {W}_{ij} \cdot {x}_{i} ) ] . \qquad Eq . ( 1 )$$

This equation states that the i^{th} element of the input vector x is multiplied by the connection weights Wᵢⱼ. This product is then the argument for a hyperbolic tangent function, which results in another vector. This resulting vector is multiplied by another set of connection weights Wⱼₖ. The subscript i spans the input space (i.e., sub-process metrics). The subscript j spans the space of hidden nodes, and the subscript k spans the output space (i.e., process metrics). The connection weights are elements of matrices, and may be found, for example, by gradient search of the error space with respect to the matrix elements. The response error function for the minimization of the output response error is given by

$$C = {[ {\sum }_{j} {( t - r )}^{2} ]}^{1 / 2} + γ {‖ W ‖}^{2} \qquad Eq . ( 2 )$$

The first term represents the root-mean-square (“RMS”) error between the target t and the response r. The second term is a constraint that minimizes the magnitude of the connection weight W. If γ (called the regularization coefficient) is large, it will force the weights to take on small magnitude values. With this weight constraint, the response error function will try to minimize the error and force this error to the best optimal between all the training examples. The coefficient γ thus acts as an adjustable parameter for the desired degree of the nonlinearity in the model.

In all of the embodiments of the present invention, the cost function can be representative, for example, of the actual monetary cost, or the time and labor, associated with achieving a sub-process metric. The cost function could also be representative of an intangible such as, for example, customer satisfaction, market perceptions, or business risk. Accordingly, it should be understood that it is not central to the present invention what, in actuality, the cost function represents; rather, the numerical values associated with the cost function may represent anything meaningful in terms of the application. Thus, it should be understood that the “cost” associated with the cost function is not limited to monetary costs.

The condition of lowest cost, as defined by the cost function, is the optimal condition, while the requirement of a metric or operational variable to follow defined cost functions and to be within accepted value ranges represents the constraint set. Cost functions are preferably defined for all input and output variables over the operating limits of the variables. The cost function applied to the vector z of n input and output variables at the nominal (current) values is represented as ƒ(z) for z∈ [symbol] n.

For input and output variables with continuous values, a normalized cost value is assigned to each limit and an increasing piecewise linear cost function assumed for continuous variable operating values between limits. For variables with discrete or binary values, the cost functions are expressed as step functions.

In one embodiment, the optimization model (or method) comprises a genetic algorithm. In another embodiment, the optimization is as for Optimizer I described below. In another embodiment, the optimization is as for Optimizer II described below. In another embodiment, the optimization strategies of Optimization I are utilized with the vector selection and pre-processing strategies of Optimization II.

Optimizer I

In one embodiment, the optimization model is stated as follows:
Min ƒ(z)
zε [symbol] ⁿ
s.t. h(z)=a
z^{L}<z<z^{U}
where ƒ: [symbol] ⁿ→ [symbol] and h: [symbol] ⁿ→ [symbol] ⁿ.
   Vector z represents a vector of all input and output variable values, ƒ(z), the objective function, and h(z), the associated constraint vector for elements of z. The variable vector z is composed of sub-process metric inputs, and process metric outputs. The vectors z^{L} and z^{U} represent the lower and upper operating ranges for the variables of z.

In one implementation, the optimization method focuses on minimizing the cost of operation over the ranges of all input and output variables. The procedure seeks to minimize the maximum of the operating costs across all input and output variables, while maintaining all within acceptable operating ranges. The introduction of variables with discrete or binary values requires modification to handle the yes/no possibilities for each of these variables.

The following basic notation is useful in describing this optimization model.
m₁=the number of continuous input variables.
m₂=the number of binary and discrete variables.
p=the number of output variables.
m=m₁+m₂, the total number of input variables.
z^{m}^{₁}ε [symbol] ^{m}^{₁}=vector of m₁ continuous input variables.
z^{m}^{₂}ε [symbol] ^{m}^{₂}=the vector of m₂ binary and discrete input variables.
z^{p}ε [symbol] ^{p}=the vector of p continuous output variables.

Also let
zε [symbol] ⁿ=[z^{m}^{₁}, z^{m}^{₂}, z^{p}]
   the vector of all input variables and output variables for a given process run.

As mentioned above, two different forms of the cost function exist: one for continuous variables and another for the discrete and binary variables. In one embodiment, the binary/discrete variable cost function is altered slightly from a step function to a close approximation which maintains a small nonzero slope at no more than one point.

The optimization model estimates the relationship between the set of continuous input values and the binary/discrete variables [z^{m}^{₁}, z^{m}^{₂}] to the output continuous values [z^{p}]. In one embodiment, adjustment is made for model imprecision by introducing a constant error-correction factor applied to any estimate produced by the model specific to the current input vector. The error-corrected model becomes,
g′(z^{m}^{₁}, z^{m}^{₂})=g(z^{m}^{₁}, z^{m}^{₂})+e₀
   where
e₀=m₀+g(z₀^{m}^{₁}, z₀^{m}^{₂}).
g(z^{m}^{₁}, z^{m}^{₂})=the prediction model output based on continuous input variables.
g: [symbol] ^{m}^{₁}^{+m}^{₂}→ [symbol] ^{p} binary and discrete input variables.
g(z₀^{m}^{₁}, z₀^{m}^{₂})=the prediction model output vector based on current input variables.
m₀ε [symbol] ^{p}=the observed output vector for the current (nominal) state of inputs.
h(z)=the cost function vector of all input and output variables of a given process run record.
h(z(i))=the i^{th} element of the cost function vector, for i=1, . . . , m+p.
   For the continuous input and output variables, cost value is determined by the piecewise continuous function. For the p continuous output variables
[h(z(m+1)), h(z(m+2)), . . . , h(z(m+p))]=g(z^{m}^{₁}, z^{m}^{₂}).

For h(z), the cost function vector for all the input and output variables of a given process run record, the scalar max h(z)=max{h(z(i)): i=1, 2, . . . , m+p}, is defined as the maximum cost value of the set of continuous input variables, binary/discrete input variables, and output variables.

The optimization problem, in this example, is to find a set of continuous input and binary/discrete input variables which minimize h(z). The binary/discrete variables represent discrete metrics (e.g., quality states such as poor/good), whereas the adjustment of the continuous variables produces a continuous metric space. In addition, the interaction between the costs for binary/discrete variables, h(z^{m}^{₂}), and the costs for the continuous output variables, h(z^{p}), are correlated and highly nonlinear. In one embodiment, these problems are addressed by performing the optimization in two parts: a discrete component and continuous component. The set of all possible sequences of binary/discrete metric values is enumerated, including the null set. For computational efficiency, a subset of this set may be extracted. For each possible combination of binary/discrete values, a continuous optimization is performed using a general-purpose nonlinear optimizer, such as dynamic hill climbing or feasible sequential quadratic programming, to find the value of the input variable vector,

$${z}_{opt}^{m} ,$$

that minimizes the summed total cost of all input and output variables

$$min f ( z ) = {\sum }_{i = 1}^{m + p} h ( {z}_{opt} ( i ) ) .$$

Optimizer II

In another embodiment, a heuristic optimization method designed to complement the embodiments described under Optimizer I is employed. The principal difference between the two techniques is in the weighting of the input-output variable listing. Optimizer II favors adjusting the variables that have the greatest individual impacts on the achievement of target output vector values, e.g., the target process metrics. Generally, Optimizer II achieves the specification ranges with a minimal number of input variables adjusted from the nominal. This is referred to as the “least labor alternative.” It is envisioned that when the optimization output of Optimizer II calls for adjustment of a subset of the variables adjusted using the embodiments of Optimizer I, these variables represent the principal subset involved with the achievement of the target process metric. The additional variable adjustments in the Optimization I algorithm may be minimizing overall cost through movement of the input variable into a lower cost region of operation.

In one embodiment, Optimization II proceeds as follows:
Min ƒ (z)
zεΦ
s.t. h(z)=a
z^{L}≦z≦z^{U}
where Φ={z^{j}ε [symbol] ⁿ:j≦sεI; an s vector set}.
ƒ: [symbol] ⁿ→ [symbol] and h: [symbol] ⁿ→ [symbol] ⁿ.
   The index j refers to the j^{th} vector of a total of s vectors of dimension n=m+p, the total number of input plus output variables, respectively, which is included in the set to be optimized by ƒ. The determination of s discrete vectors from an original vector set containing both continuous and binary/discrete variables may be arrived at by initial creation of a discrete rate change from nominal partitioning. For each continuous variable, several different rate changes from the nominal value are formed. For the binary variables only two partitions are possible. For example, a continuous variable rate-change partition of −0.8 specifies reduction of the input variable by 80% from the current nominal value. The number of valid rate partitions for the m continuous variables is denoted as nₘ.

A vector z is included in Φ according to the following criterion. (The case is presented for continuous input variables, with the understanding that the procedure follows for the binary/discrete variables with the only difference that two partitions are possible for each binary variable, not nm.) Each continuous variable is individually changed from its nominal setting across all rate partition values while the remaining m−1 input variables are held at nominal value. The p output variables are computed from the inputs, forming z.

Inclusion of z within the set of vectors to be cost-optimized is determined by the degree to which the output variables approach targeted values. The notation zᵢₖ(l)ε [symbol] , l=1, 2, . . . p, refers to the l^{th} output value obtained when the input variable vector is evaluated at nominal variable values with the exception of the i^{th} input variable which is evaluated at its k^{th} rate partition. In addition, zᵢₖε [symbol] is the value of the i^{th} input variable at its k^{th} rate partition from nominal. The target value for the l^{th} output variable l=1, 2, . . . p is target (l) and the l^{th} output variable value for the nominal input vector values is denoted z₀(l).

The condition for accepting the specific variable at a specified rate change from nominal for inclusion in the optimization stage is as follows.

For each i≦m, and each k≦nₘ
if |(zᵢₖ(l)−target(l))/(z₀(l)−target(l))|<K(l)
for l≦p, 0≦K(l)≦1, and z^{L}≦zᵢ^{j}≦z^{U}
then zᵢₖεΔᵢ=acceptable rate partitioned values of the i^{th} input variable.
   To each set Δᵢ, i=1, . . . , m is added the i^{th} nominal value. The final set Φ of n-dimension vectors is composed of the crossing of all the elements of the sets Δᵢ of acceptable input variable rate-partitioned values from nominal. Thus, the total number of vectors zεΦ equals the product of the dimensions of the Δᵢ:
Total vectors εΦ

$$Total vectors ∈ Φ = ( {\prod }_{i}^{{m}_{1}} {n}_{i} ) * ( {2}^{{m}_{2}} )$$
for m₁=the number of continuous input variables
   m₂=the number of binary and discrete variables.

The vector set Φ resembles a fully crossed main effects model which most aggressively approaches one or more of the targeted output values without violating the operating limits of the remaining output values.

This weighting strategy for choice of input vector construction generally favors minimal variable adjustments to reach output targets. In one embodiment, the Optimization II strategy seeks to minimize the weighted objective function

$$f ( {z}^{j} ) = {\sum }_{i = 1}^{m} f ( {z}_{i}^{j} ) + pV {( {\prod }_{i = m + 1}^{m + p} f ( {z}_{i}^{j} ) )}^{1 / p}$$

for pV. The last p terms of z are the output variable values computed from the n inputs. The term

$${( {\prod }_{i = m + 1}^{m + p} f ( {z}_{i}^{j} ) )}^{1 / p}$$

is intended to help remove sensitivity to large-valued outliers. In this way, the approach favors the cost structure for which the majority of the output variables lie close to target, as compared to all variables being the same mean cost differential from target.

Values of pV>>3 represent weighting the adherence of the output variables to target values as more important than adjustments of input variables to lower cost structures that result in no improvement in quality.

In another embodiment, the Optimization II method seeks to minimize the weighted objective function

$$f ( {z}^{j} ) = {\sum }_{i = 1}^{m} f ( {z}_{i}^{j} ) + V ( {\prod }_{i = m + 1}^{m + p} f ( {z}_{i}^{j} ) )$$

for V. The last p terms of z are the output variable values computed from the n inputs.
Integrated Circuit Fabrication Metalization Process Example

An illustrative description of the invention in the context of a metalization process utilized in the production of integrated circuits is provided below. However, it is to be understood that the present invention may be applied to any integrated circuit production process including, but not limited to, plasma etch processes and via formation processes. More generally, it should be realized that the present invention is generally applicable to any complex multi-step production processes, such as, for example, circuit board assembly, automobile assembly and petroleum refining.

The following example pertains to a metalization layer process utilized during the manufacture of integrated circuits. Examples of input variables for a non-linear regression model of a metalization process or sub-process are listed in the following Table 1, and include sub-process operational variables “process variables” and “maintenance variables” columns, and sub-process metrics, “metrology variables” column. Examples of output variables for a nonlinear regression model of a metalization process or sub-process are also listed in Table 1, which include sub-process metrics, “metrology variables” column, and process metrics “yield metric” column.

TABLE 1

| input variables | | output variable | |
|---|---|---|---|
| process | maintenance | metrology | yield |
| variables | variables | variables | metric |
| cvd tool id | cvd tool mfc1 | cvd control wafer | via chain |
| | | | resistance |
| cvd tool pressure | cvd tool mfc2 | cmp control wafer | |
| cvd tool gas flow | cvd tool mfc3 | cmp product wafer | |
| cvd tool | cvd tool electrode | litho/pr control | |
| termperature | | wafer | |
| cvd tool . . . | cvd tool up time | litho/pr product | |
| | | wafer | |
| cmp tool id | cmp tool pad | etch control wafer | |
| cmp tool speed | cmp tool slurry | etch product wafer | |
| cmp tool slurry | cmp pad moter | | |
| cmp tool | cmp calibration | | |
| temperature | | | |
| cmp tool . . . | cmp tool up time | | |
| litho tool id | litho tool lamp | | |
| litho tool x, y, z | litho tool | | |
| | calibration | | |
| litho tool . . . | litho tool up time | | |
| etch tool id | etch tool electrode | | |
| etch tool pressure | etch tool mfc1 | | |
| etch tool rf power | etch tool mfc2 | | |
| etch tool gas flow | etch tool clamp | | |
| | ring | | |
| etch tool | etch tool rf match | | |
| temperature | box | | |
| etch tool . . . | etch tool up time | | |

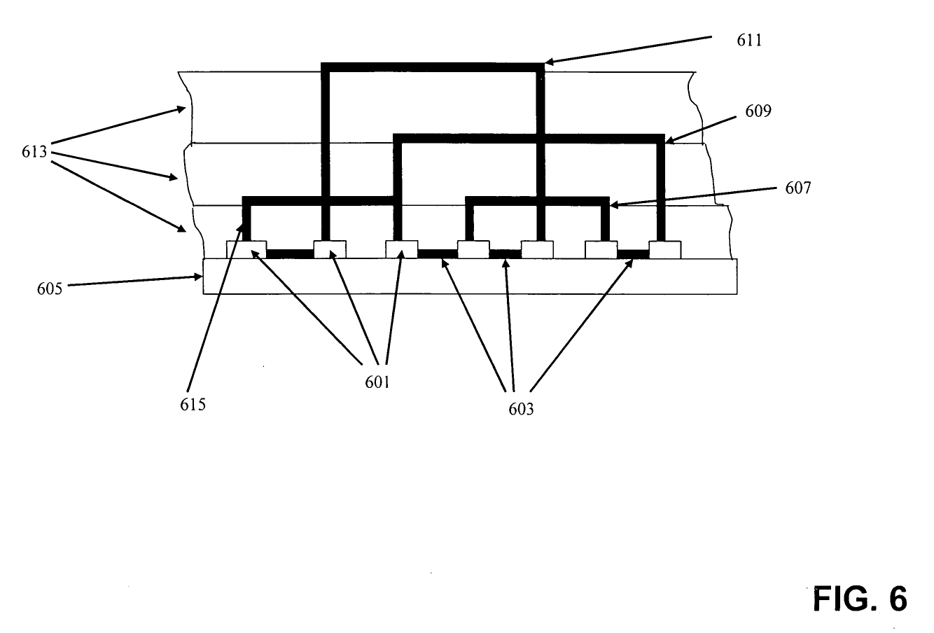

Prior to the first layer of metalization, the transistors 601 are manufactured and a first level of interconnection 603 is prepared. This is shown schematically in FIG. 6. The details of the transistor structures and the details of the metal runners (first level of interconnect) are not shown.

The first step in the manufacture of integrated circuits is typically to prepare the transistors 601 on the silicon wafer 605. The nearest neighbors that need to be connected are then wired up with the first level of interconnection 603. Generally, not all nearest neighbors are connected; the connections stem from the circuit functionality. After interconnection, the sequential metalization layers, e.g., a first layer 607, a second layer 609, a third layer 611, etc., are fabricated where the metalization layers are separated by levels of oxide 613 and interconnected by vias 615.

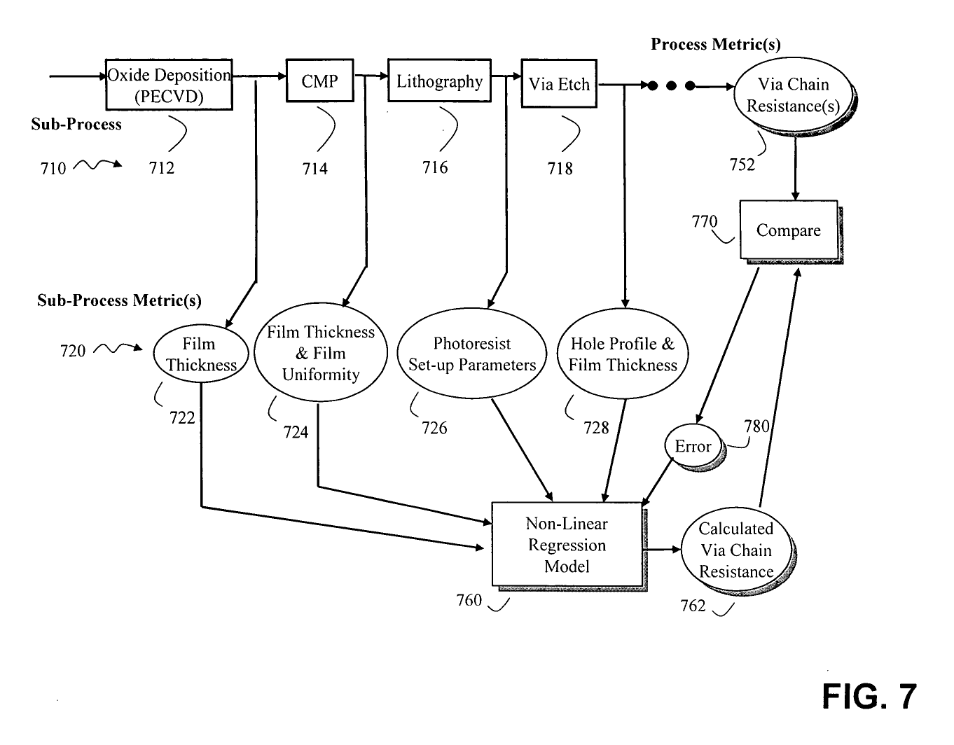

FIG. 7 schematically illustrates four sequential processing steps 710, i.e., sub-processes, that are associated with manufacturing a metal layer (i.e., the metalization layer process). These four processing steps are: (1) oxide deposition 712; (2) chemical mechanical planerization 714; (3) lithography 716; and (4) via etch 718. Also illustrated are typical associated sub-process metrics 720.

Oxide deposition, at this stage in integrated circuit manufacture, is typically accomplished using a process known as PECVD (plasma-enhanced chemical vapor deposition), or simply CVD herein. Typically, during the oxide deposition sub-process 712 a blank monitor wafer (also known as a blanket wafer) is run with each batch of silicon wafers. This monitor wafer is used to determine the amount of oxide deposited on the wafer. Accordingly, on a lot to lot basis there are typically one or more monitor wafers providing metrology data (i.e., metrics for the sub-process) on the film thickness, as grown, on the product wafer. This film thickness 722 is a metric of the oxide-deposition sub-process.

After the oxide-deposition sub-process, the wafers are ready for the chemical mechanical planarization (“CMP”) processing step 714. This processing step is also referred to as chemical mechanical polishing. CMP is a critical sub-process because after the growth of the oxide, the top surface of the oxide layer takes on the underlying topology. Generally, if this surface is not smoothed the succeeding layers will not match directly for subsequent processing steps. After the CMP sub-process, a film thickness may be measured from a monitor wafer or, more commonly, from product wafers. Frequently, a measure of the uniformity of the film thickness is also obtained. Accordingly, film thickness and film uniformity 724 are in this example the metrics of the CMP sub-process.

Following the CMP sub-process is the lithography processing step 716, in which a photoresist is spun-on the wafer, patterned, and developed. The photoresist pattern defines the position of the vias, i.e., tiny holes passing directly through the oxide layer. Vias facilitate connection among transistors and metal traces on different layers. This is shown schematically in FIG. 6. Typically, metrics of the lithography sub-process may include the photoresist set-up parameters 726.

The last sub-process shown in FIG. 7 is the via etch sub-process 718. This is a plasma etch designed to etch tiny holes through the oxide layer. The metal interconnects from layer to layer are then made. After the via etch, film thickness measurements indicating the degree of etch are typically obtained. In addition, measurements of the diameter of the via hole, and a measurement of any oxide or other material in the bottom of the hole, may also be made. Thus, in this example, two of these measurements, film thickness and via hole profile 728, are used as the via etch sub-process metrics.

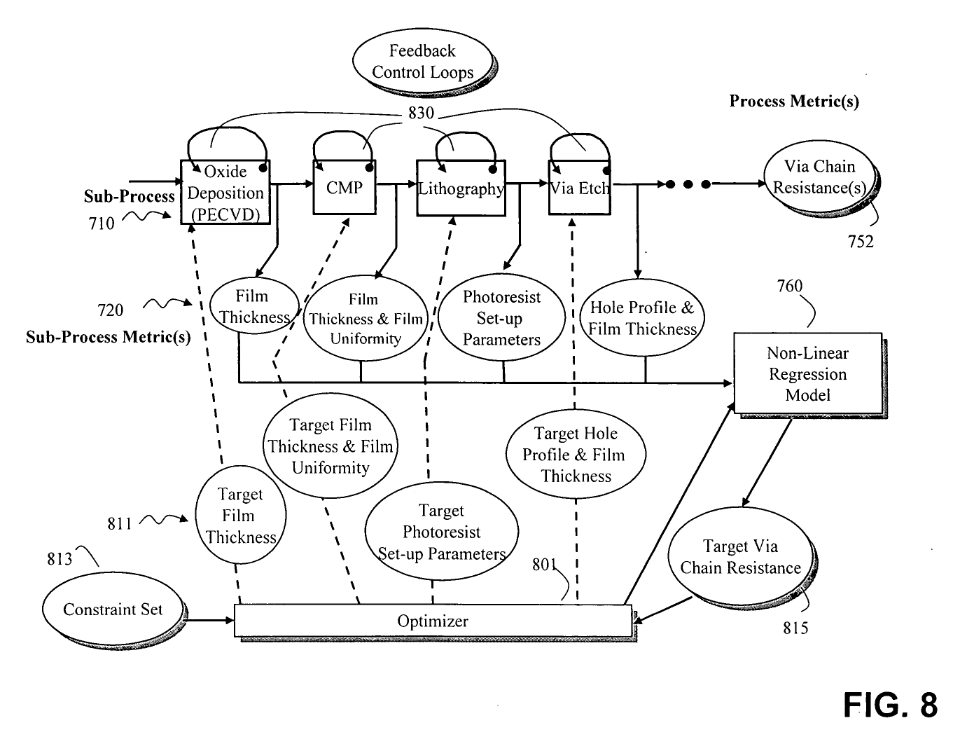

Not shown in FIG. 7 (or FIG. 8) is the metal deposition processing step. The metal deposition sub-process comprises sputter deposition of a highly conductive metal layer. The end result can be, for example, the connectivity shown schematically in FIG. 6. (The metal deposition sub-process is not shown to illustrate that not every sub-process of a given process need be considered to practice and obtain the objectives of the present invention. Instead, only a certain subset of the sub-processes may be used to control and predict the overall process.)

Each metal layer is prepared by repeating these same sub-process steps. Some integrated microelectronic chips contain six or more metal layers. The larger the metal stack, the more difficult it is to manufacture the devices.

When the wafers have undergone a metalization layer process, they are typically sent to a number of stations for testing and evaluation. Commonly, during each of the metalization layer processes there are also manufactured on the wafer tiny structures known as via-chain testers or metal-to-metal resistance testers. The via chain resistance 752 measured using these structures represents the process metric of this example. This process metric, also called a yield metric, is indicative of the performance of the cluster of processing steps, i.e., sub-processes. Further, with separate via-chain testers for each metalization layer process, the present invention can determine manufacturing faults at individual clusters of sub-processes.

In one embodiment, the sub-process metrics from each of the sub-processes (processing steps) become the input to a nonlinear regression model 760. The output for this model is the calculated process metric 762; in the present example, this is the via-chain resistance. The nonlinear regression model is trained as follows.

The model calculates a via-chain resistance 762 using the input sub-process metrics 720. The calculated via chain resistance 762 is compared 770 with the actual resistance 752 as measured during the wafer-testing phase. The difference, or the error, 780 is used to compute corrections to the adjustable parameters in the regression model 760. The procedure of calculation, comparison, and correction is repeated with other training sets of input and output data until the error of the model reaches an acceptable level. An illustrative example of such a training scheme is shown schematically in FIG. 7.

After the nonlinear regression model, or neural network, is trained it is ready for optimization of the sub-process metrics. FIG. 8 schematically illustrates the optimization of the sub-process metrics 720 with an “optimizer” 801. The optimizer 801 operates according to the principles hereinabove described, determining target sub-process metrics 811 that are within the constraint set 813 and are predicted to achieve a process metric(s) as close to the target process metric(s) 815 as possible while maintaining the lowest cost feasible. The optimization procedure begins by setting an acceptable range of values for the sub-process metrics to define a sub-process metric constraint set 813 and by setting one or more target process metrics 815. The optimization procedure then optimizes the sub-process metrics against a cost function for the sub-process metrics.

For example, in the metalization layer process, the constraint set 813 could comprise minimum and maximum values for the oxide deposition film thickness metric, the CMP film thickness and film uniformity metrics, the lithography photoresist set up parameters, and the via etch hole profile and film thickness metrics. The target process metric, via chain resistance 815, is set at a desired value, e.g., zero. After the nonlinear regression model 760 is trained, the optimizer 801 is run to determine the values of the various sub-process metrics (i.e., target sub-process metrics 811) that are predicted to produce a via chain resistance as close as possible to the target value 815 (i.e., zero) at the lowest cost.

Referring to FIG. 8, in another embodiment, an additional level of prediction and control is employed. This additional level of prediction and control is illustrated in FIG. 8 by the loop arrows labeled “feedback control loop” 830. In one such embodiment, a map is determined between the operational variables of a sub-process and the metrics of that sub-process, and a cost function is provided for the sub-process operational variables. Employing the map and cost function, values for the sub-process operational variables are determined that produce at the lowest cost the sub-process metric, and that are as close as possible to the target sub-process metric values, to define target operational variables. In another embodiment, an acceptable range of values for the sub-process operational variables is identified to define a sub-process operational variable constraint set, and the operational variables are then optimized such that the target operational variables fall within the constraint set.

In one embodiment, the optimization method comprises a genetic algorithm. In another embodiment, the optimization is as for Optimizer I described above. In another embodiment, the optimization is as for Optimizer II described above. In yet another embodiment, the optimization strategies of Optimization I are utilized with the vector selection and pre-processing strategies of Optimization II.

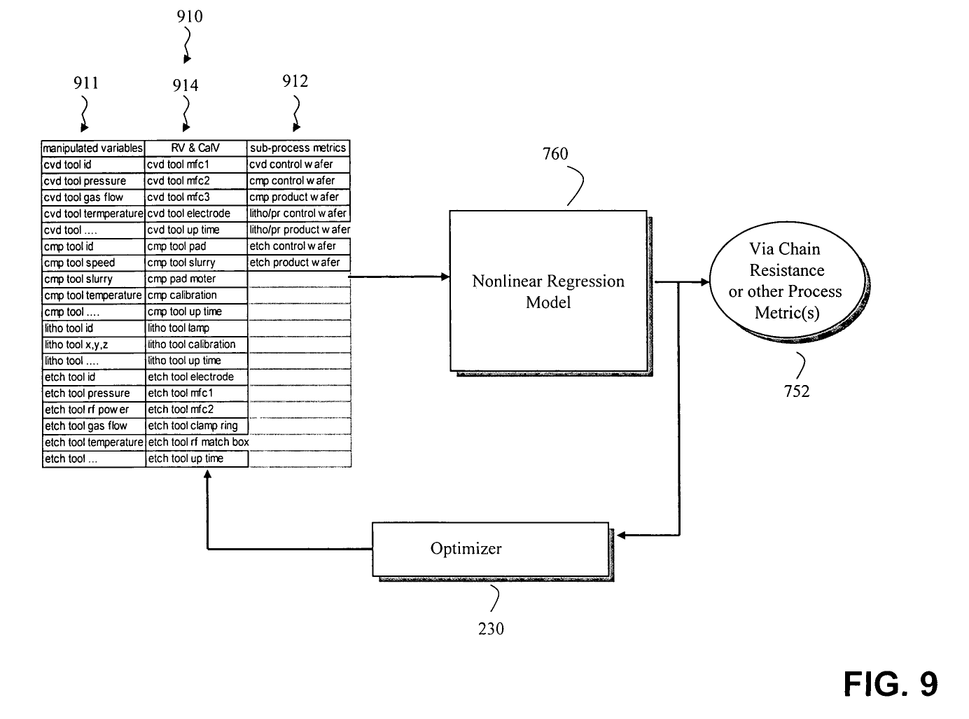

FIG. 9 schematically illustrates an embodiment of the invention, in the context of the present metalization layer process example, that comprises determining a map between the sub-process metrics and sub-process operational variables and the process metrics using a nonlinear regression model. As illustrated, the input variables 910 to the nonlinear regression model 760 comprise both process metrics 912 and sub-process operational variables 914, 916.

FIG. 9 further illustrates that in this embodiment, the optimizer 920 acts on both the sub-process metrics and operational parameters to determine values for the sub-process metrics and operational variables that are within the constraint set, and that produce at the lowest cost a process metric(s) 752 that is as close as possible to the a target process metric(s) to define target sub-process metrics and target operational variables for each sub-process.

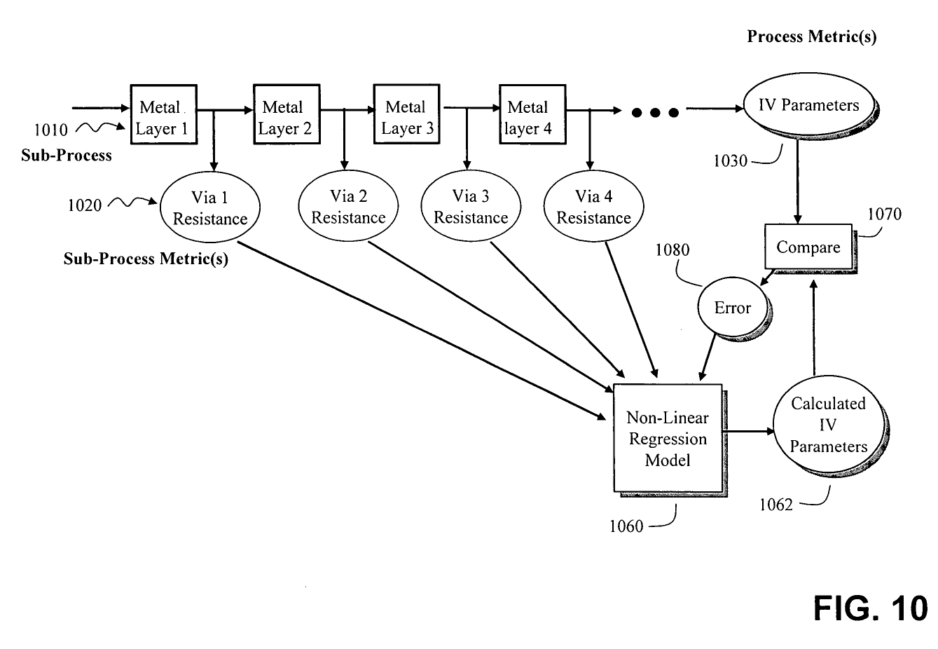

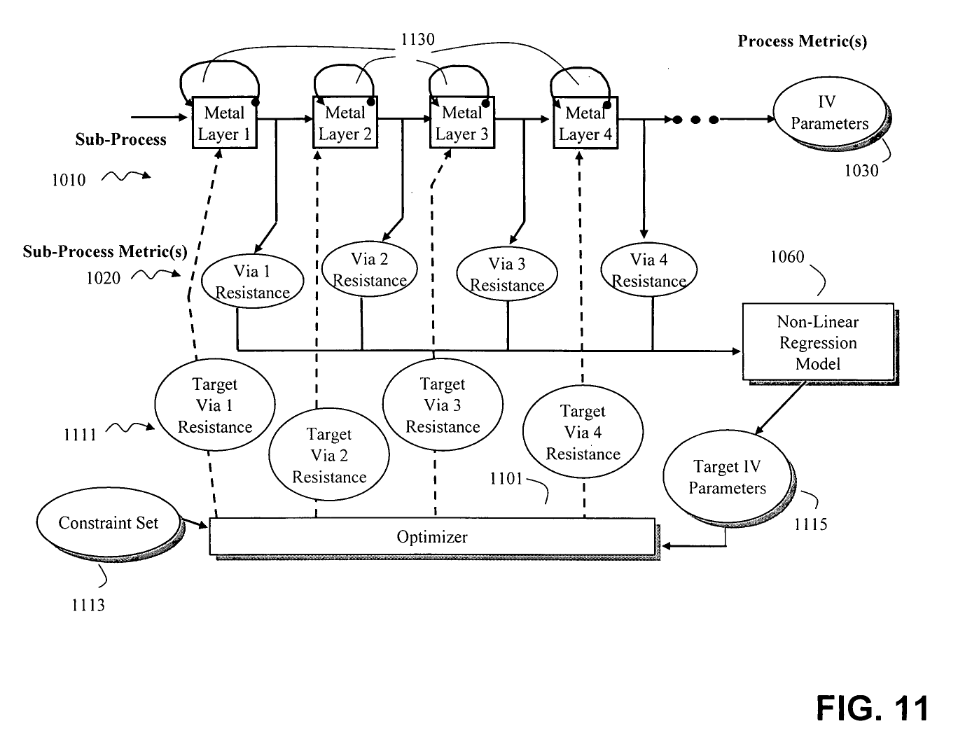

Referring to FIGS. 10 and 11, and the metalization layer process described above, one embodiment of the present invention comprises a hierarchical series of sub-process and process models. As seen in FIG. 6, there are several levels of metalization. As illustrated in FIG. 10, a new model is formed where each metalization layer process performed, such as illustrated in FIGS. 7 and 8, becomes a sub-process 1010 in a new higher level process, i.e., complete metalization in this example. As illustrated in FIGS. 10 and 11, the sub-process metrics 1020 are the via chain resistances of a given metalization layer process, and the process metrics of the complete metalization process are the IV (current-voltage) parameters 1030 of the wafers. FIG. 10 provides an illustrative schematic of training the nonlinear regression model 1060 for the new higher level process, and FIG. 11 illustrates its use in optimization.

Referring to FIG. 10, the nonlinear regression model 1060 is trained in the relationship between the sub-process metrics 1020 and process metric(s) 1030 in a manner analogous to that illustrated in FIG. 7. The sub-process metrics 1020 from each of the sub-processes 1010 (here metalization steps) become the input to the nonlinear regression model 1060. The output for this model is the calculated process metrics 1062; in the present example, these are the IV parameters. The nonlinear regression model is trained as follows.

The model calculates IV parameters 1062 using the input sub-process metrics 1020. The calculated IV parameters 1062 are compared as indicated at 1070 with the actual IV parameters as measured during the wafer-testing phase 1030. The difference, or the error, 1080 is used to compute corrections to the adjustable parameters in the regression model 1060. The procedure of calculation, comparison, and correction is repeated with other training sets of input and output data until the error of the model reaches an acceptable level.

Referring again to FIG. 11, after the nonlinear regression model, or neural network, 1060 is trained it is ready for optimization of the sub-process metrics 1020 in connection with an “optimizer” 1101. The optimizer 1101 determines target sub-process metrics 1111 that are within the constraint set 1113 and are predicted to achieve a process metric(s) as close to the target process metric(s) 1115 as possible while maintaining the lowest cost feasible. The optimization procedure begins by setting an acceptable range of values for the sub-process metrics to define a sub-process metric constraint set 1113 and by setting one or more target process metrics 1115. The optimization procedure then optimizes the sub-process metrics against a cost function for the sub-process metrics.

For example, in the overall metalization process, the constraint set 1113 may comprise minimum and maximum values for the via chain resistances of the various metal layers. The target process metric, IV parameters, 1115 are set to desired values and the optimizer 1101 is run to determine the values of the various sub-process metrics (i.e., target sub-process metrics 1111) that are predicted to produce IV parameters as close as possible (e.g., in a total error sense) to the target value 1115 at the lowest cost.

In another embodiment, an additional level of prediction and control is employed. This additional level of prediction and control is illustrated in FIG. 11 by the feedback control loop arrows 1130. In one such embodiment, a map is determined between the operational variables of a sub-process and the metrics of that sub-process, and a cost function is provided for the sub-process operational variables, which in this example may also be the operational variables of a sub-sub-process. Employing the map and cost function, values for the sub-process operational variables are determined that produce at the lowest cost the sub-process metric, and that are as close as possible to the target sub-process metric values, to define target operational variables. In another embodiment, an acceptable range of values for the sub-process operational variables is identified to define a sub-process operational variable constraint set, and the operational variables are then optimized such that the target operational variables fall within the constraint set.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A system for controlling a process having a plurality of sub-processes and having associated processing metrics, the system comprising:
a plurality of sensors for obtaining operational metrics from a plurality of tools performing the sub-processes;
a yield controller, responsive to the sensors, for predicting output performance of the process based on the operational metrics corresponding to individual sub-processes; and
an optimizer for determining one or more actions to be taken affecting one or more of the sub-processes based on the predicted output performance, thereby maximizing process performance.

2. The system of claim 1 further comprising a plurality of tool controllers, each tool controller being associated with one or more of the plurality of tools, for implementing the actions determined by the optimizer.

3. The system of claim 1 wherein the actions comprise part replacements.

4. The system of claim 1 wherein the actions comprise recipe adjustments.

5. The system of claim 1 wherein the actions comprise maintenance actions to be performed on one or more of the tools.

6. The system of claim 1 wherein the yield controller further comprises a high-level process controller for determining relationships between the operational metrics and the output performance of the process.

7. The system of claim 6 wherein the high-level process controller uses a nonlinear regression model to model the relationships between the operational metrics and the output performance of the process.

8. The system of claim 7 wherein the nonlinear regression model comprises a neural network.

9. The system of claim 6 wherein the yield controller further comprises a low-level process controller for determining relationships between the output performance of the process and the actions affecting one or more of the sub-processes.

10. The system of claim 9 wherein the low-level process controller uses a nonlinear regression model to model the relationships between the output performance of the process and the actions affecting one or more of the sub-processes.

11. The system of claim 10 wherein the nonlinear regression model comprises a neural network.

12. The system of claim 1 further comprising a data storage module, in communication with the yield controller, for storing at least one of target process metrics; corrective action costs; maintenance actions; process state information; and possible corrective actions.

13. An article of manufacture having a computer-readable medium with computer-readable instructions embodied thereon for performing the method of claim 1.

14. A method for controlling a complex process comprising multiple sub-processes, the method comprising:
extracting operational metrics from a plurality of tools performing the sub-processes;
based on the operational metrics corresponding to individual sub-processes, predicting the output performance of the process; and
determining one or more actions to be taken affecting one or more of the sub-processes based on the predicted output performance, thereby maximizing process performance.

15. The method of claim 14 further comprising implementing the actions on one or more of the tools performing the sub-processes.

16. The method of claim 14 wherein the actions comprise part replacements.

17. The method of claim 14 wherein the actions comprise recipe adjustments.

18. The method of claim 14 wherein the actions comprise maintenance actions to be performed on one or more of the tools.

19. The method of claim 14 further comprising determining relationships between the operational metrics and the output performance of the process.

20. The method of claim 19 further comprising using a nonlinear regression model to model the relationships between the operational metrics and the output performance of the process.

21. The method of claim 20 wherein the nonlinear regression model comprises a neural network.

22. The method of claim 14 further comprising determining relationships between the output performance of the process and the actions affecting one or more of the sub-processes.

23. The method of claim 22 comprising using a nonlinear regression model to model the relationships between the output performance of the process and the actions affecting one or more of the sub-processes.

24. The method of claim 23 wherein the nonlinear regression model comprises a neural network

25. The method of claim 14 wherein the one or more actions to be taken affecting one or more of the sub-processes are further based on at least one of target process metrics, corrective action costs, maintenance actions, process state information, and possible corrective actions.
